(19) United States
(12) Patent Application Publication
(10) Pub. No.: US 2008/0271857 A1
(43) Pub. Date: Nov. 6, 2008

(54) Foldable shades for aircraft cockpits

(76) Inventor: Linda Kay Swadling, Ft. Walton Beach, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/800,447

(22) Filed: May 4, 2007

(51) Int. Cl. E06B 3/80

(52) U.S. Cl. 160/179; 244/121

(57) ABSTRACT

Disclosed is a system for shielding the interior of an aircraft cockpit. The system utilizes a number of individual shades that can be deployed over the various windshields that make up the canopy of an aircraft cockpit. Each shade has both a substantially flat, deployed configuration and a folded, stowed configuration. In the deployed configuration, the edges of the shade can be secured within the edges surrounding an associated canopy windshield. In this manner the shade is retained adjacent the windshield and is used to reflect sunlight and otherwise protect the internal components of the cockpit from direct sunlight. The shade can be deployed over a windshield in any orientation due to a resilient wire loop that is positioned within a peripheral edge of the shade. In the stowed configuration, the shade is folded over onto itself for storage and transport. The various details of the present invention, and the manner in which they inter-relate, and are described in greater detail hereinafter.

### BACKGROUND OF THE INVENTION

1. Field of the Invention

This invention relates to an improved construction for an aircraft canopy shade. More particularly, the present invention relates to a shade that can be resiliently retained adjacent the inside surface of an aircraft windshield and that can be folded into a compact configuration for storage and transport.

2. Description of the Background Art

The background art contains many examples of sunshades that are specifically adapted or configured for use within an automobile. These shades are securable to fixtures commonly found within automobiles or otherwise rest within an automobile windshield. For instance, U.S. Pat. No. 6,938,942 to Ytterberg discloses an auxiliary windshield sunvisor that includes a panel envelope formed from a closed loop of spring-like material located about an interior perimeter of the envelope. The sunvisor includes a compliant compressive spring force that retains it adjacent the roofline, over the rearview mirror, and in between adjacent conventional visors.

The background art also contains various examples of foldable automobile sunshields. For instance, U.S. Pat. No. 5,628, 357 to Hwang discloses an automobile sunshield that is designed to fit within the left and right sides of the windshield as well as in the four corners of the windshield. The sunshield is constructed from two opposing spring loops that can be twisted to fold the sunshield. A bias tape can be sewn into the periphery of the shield.

Similarly, U.S. Pat. No. 5,213,147 to Zheng discloses an apparatus for folding and collapsing objects supported by flexible loops. The apparatus can be used in the construction of an automobile sunshade. The sunshade is formed from a large flexible loop and is foldable by way of a cable that has two of its ends connected to two points along the loop. By pulling the cable, three smaller loops are formed from the larger loop. The smaller loops thereafter can be collapsed by twisting and folding such that they are overlying one another.

Yet another example of a foldable automobile sunshade is disclosed in U.S. Pat. No. 5,024,262 to Huang, which discloses an automobile window sunshade that can be folded for storage. The sunshade includes a single elongated loop of a thin strip of spring-like material that is covered by a sheet of flexible material. The fabric-covered loop can be twisted and folded into a compact configuration.

Finally, U.S. Pat. No. 4,815784 to Zheng discloses a collapsible elongated automobile sunshield which is made up of a plurality of adjacent collapsible flexible loop members. The loop members are covered by a fabric material and are interconnected by a hinge. The loop portions can be folded on top of each other about the hinge to form a plurality of concentric rings to substantially reduce the size of the shade.

Thus, the background art is primarily directed at overcoming problems unique to shielding automobile interiors. For this reason, the above referenced shields are specifically designed and configured to be deployed over an automobile windshield. By contrast, the present invention is directed to overcoming problems unique to shielding the interior of an aircraft cockpit.

### SUMMARY OF THE INVENTION

It is therefore one of the objects of this invention to design a foldable sunshade that is specifically configured to be deployed within the interior of an aircraft cockpit.

It is also an object of this invention to create a system for shielding an aircraft cockpit by providing a plurality of aircraft covers each of which is dimensioned to overlie a windshield of an aircraft canopy.

It is still another object of this invention to facilitate use of a plurality of aircraft covers by providing a means to conveniently store and transport the plurality of covers.

Still yet another object of this invention is to create an aircraft cover that can be securely and positively maintained over the interior surface of an aircraft windshield at any orientation and without the need for additional fasteners or securement.

These and other objects are carried out by providing an aircraft shielding system that includes an aircraft canopy with at least one windshield that is oriented or positionable in a substantially horizontal plane and which includes a peripheral edge. The system also includes a shade that has a shape and size that corresponds to the windshield. The shade has an interior area and a peripheral edge. The shade further includes a stiffener that is secured within the peripheral edge of the shade and which has a spring force sufficient to retain the shade within the peripheral edge of the windshield while the windshield is in the horizontal plane.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a prospective view of an aircraft canopy with multiple windshields and associated aircraft shades.

FIG. 2 is a detailed view of one of the canopy windshields showing the manner in which an individual shade is secured within the edges of the windshield.

FIG. 3 is a sectional view of the canopy and windshield taken along line 3-3 of FIG. 2.

FIGS. 4-7 illustrate a particular aircraft shade being folded from a deployed orientation to a stowed orientation.

FIGS. 8-14 illustrate another aircraft shade being folded from a deployed orientation to a stowed orientation.

FIG. 15 is a view of the carrying case for use in storing and transporting a plurality of shades.

Similar reference characters refer to similar parts of throughout the several views of the drawings.

### DETAILED DESCRIPTION OF THE PREFERRED EMBODIMENT

The present invention relates to a system for shielding the interior of an aircraft cockpit. The system utilizes a number of individual shades that can be internally deployed over the various windshields that make up the canopy of an aircraft cockpit. Each shade has both a substantially flat, deployed configuration and a folded, stowed configuration. In the deployed configuration, the edges of the shade can be secured within the edges surrounding the internal surface of an associated canopy windshield. In this manner the shade is retained adjacent the windshield and is used to reflect sunlight and otherwise protect the internal components of the cockpit from direct sunlight. The shade can be deployed over a windshield in any orientation due to a resilient wire loop that is positioned within a peripheral edge of the shade. In the stowed configuration, the shade is folded over onto itself for storage and transport. The various details of the present invention, and the manner in which they inter-relate, are described in greater detail hereinafter.

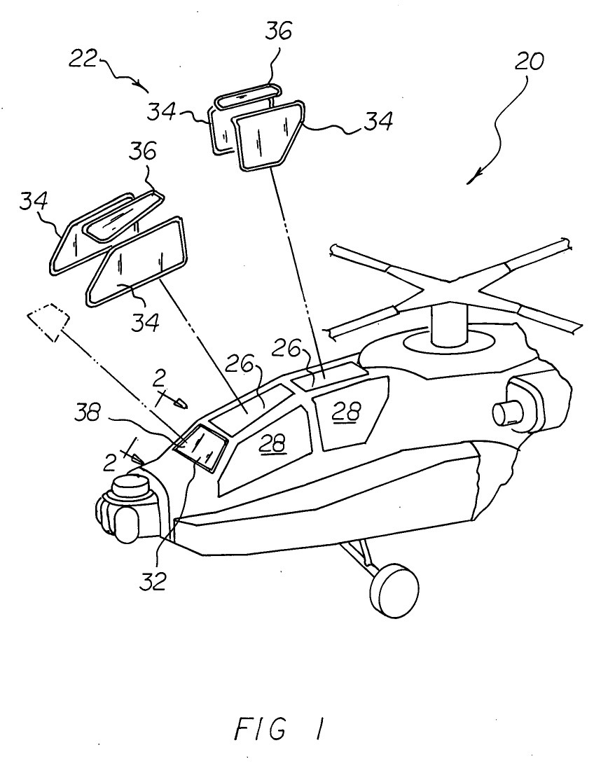

FIG. 1 is a prospective illustration showing a particular aircraft 20 that would benefit from the shade system 22 of the present invention. The aircraft 20 depicted in FIG. 1 is a Boeing AH-64 Apache Longbow. The Longbow includes a series of windshields that make up a canopy 24 that overlies a cockpit. The cockpit includes seats for a pilot and co-pilot/gunner. These seats are arranged in tandem to one another and are separated by a blast shield.

The Longbow canopy 24 comprises seven different windshields: three rearward windshields for the pilot and four forward windshields for the co-pilot/gunner. FIG. 1 also illustrates the various windshield orientations that make up the Longbow canopy. Namely, the Longbow includes two overhead windshields 26 located within an upper surface of canopy 24, four side windshields 28, and one forward windshield 32. Two of the side windshields 28 are hinged and can pivot from a first substantially vertical orientation, to a substantially horizontal orientation, and to a second substantially vertical orientation to allow for the pilot and co-pilot/gunner to enter and exit aircraft 20. Canopy 24 is representative of only one type of canopy upon which system 22 of the present invention can be used. Nonetheless, maximum visibility from the cockpit is essential for all aircraft, including both fixed wing and rotary, and many aircraft canopies are similarly made up of a variety of windshields in various angular orientations. Additionally, many other aircraft types employ a hinged windshield to enter and exit the cockpit.

FIG. 1 further illustrates the various individual shades that make up system 22 of the present invention and their placement on the Longbow canopy. Normally, seven individual shades are included to cover the seven different windshields (26, 28 and 32). This includes four side shades 34, two overhead shades 36 and one forward shade 38. In each case, the particular shade (34, 36, or 38) has a shape and size that matches the shape and size of the associated windshield (26, 28, or 32). As noted herein, each of the shades (34, 36, or 30) is adapted to be secured adjacent the internal surface of the associated windshield (26, 28, or 32). Again, although the present invention is depicted as being used in conjunction with an Apache Longbow, it is understood that the invention can easily be adapted for use with other aircraft canopies. The invention finds particular application with aircraft canopies that are made up of a number of different windshields which are positioned or positionable at various orientations around and on top of a pilot and co-pilot. More specifically, the invention finds application in connection with aircraft windshields that are positioned or are positionable in a substantially horizontal plane. As used herein, substantially horizontal includes those orientations that are within 25 degrees from horizontal.

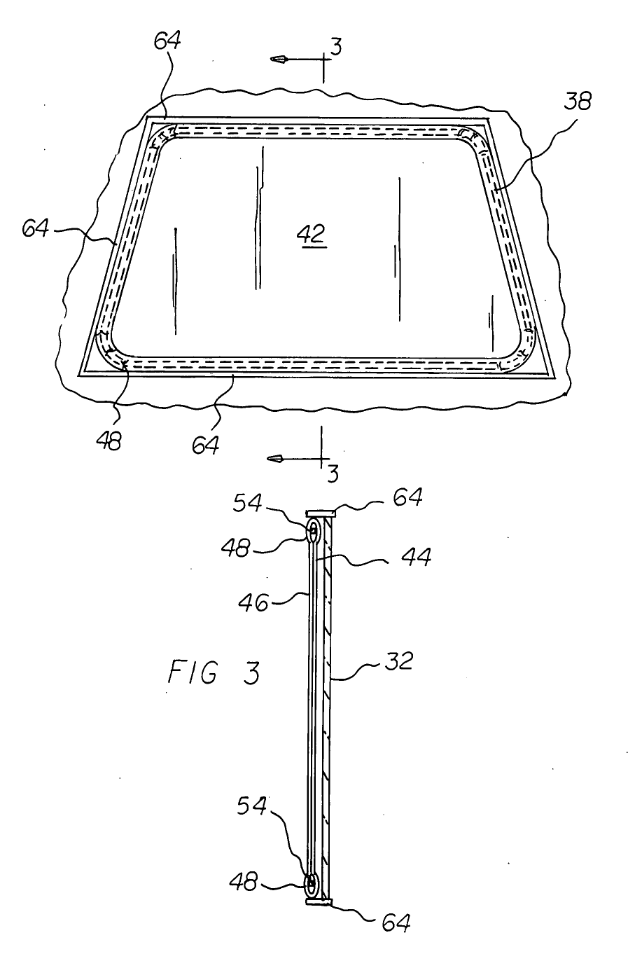

Although each of these shades (34, 36 or 38) can have a different shape and size to accommodate a variety of windshield configurations, they share a similar construction. Namely, each of the shades includes an interior area 42 made up of a flexible multi-layer material. More specifically, and as noted in FIG. 2-3, the preferred construction of the interior area 42 includes an inner layer 44 of a polyester fabric and an outer layer 46 of a reflective vinyl laminate. It has been discovered that this construction yields sufficient durability and flexibility, while at the same time adequately reflecting sunlight and otherwise insulating the internal components of the cockpit.

One suitable material for the interior area is sold under the trademark Energy Shields by Trident Industrial Products Inc. of Tamarac, Fla. Although the preferred materials for the interior area have been described, those individuals skilled in the art will appreciate alternative materials that will achieve the desired objectives of durability, flexibility, reflectiveness and insulation. These alternative materials and components can readily be used in conjunction with the present invention.

With continuing reference to FIG. 2-3, the preferred shade construction also includes a fabric sleeve 48 that is secured to the periphery of the interior area 42. The preferred sleeve is a heavy duty nylon that is sewn, stitched, or otherwise secured, to the entire peripheral edge of the shade. Sleeve 48 houses a wire loop 54 that is used to provide rigidity to the overall shade. In the preferred embodiment, wire loop 54 is a flat hoop with a thickness of ¼ inch and which is constructed from a spring steel alloy. It has been found that a spring steel alloy of this size and shape gives a sufficient degree of resilience to loop 54 to enable it to be twisted and folded onto itself as described hereinafter.

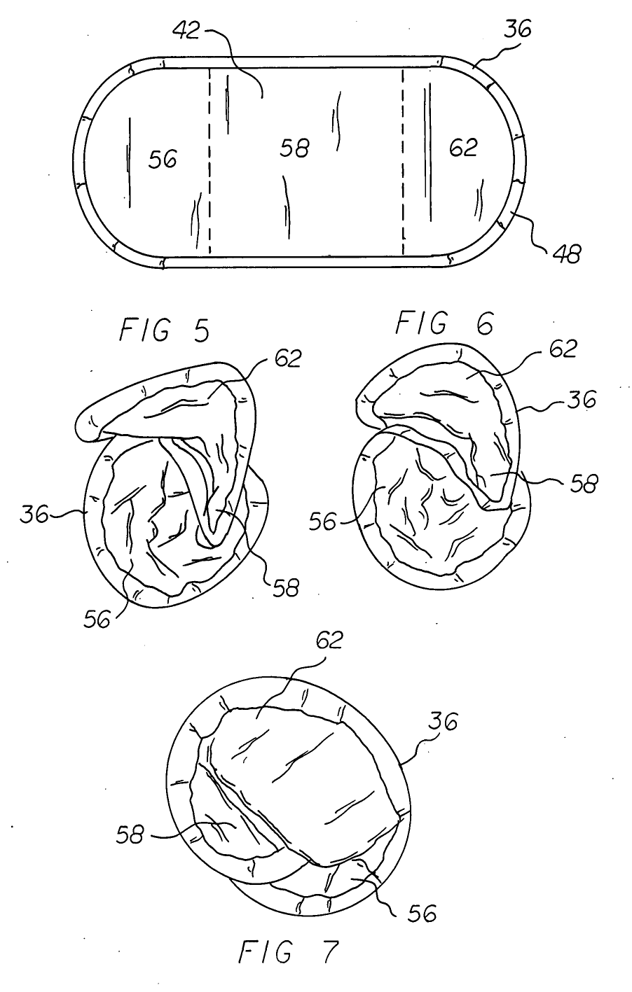

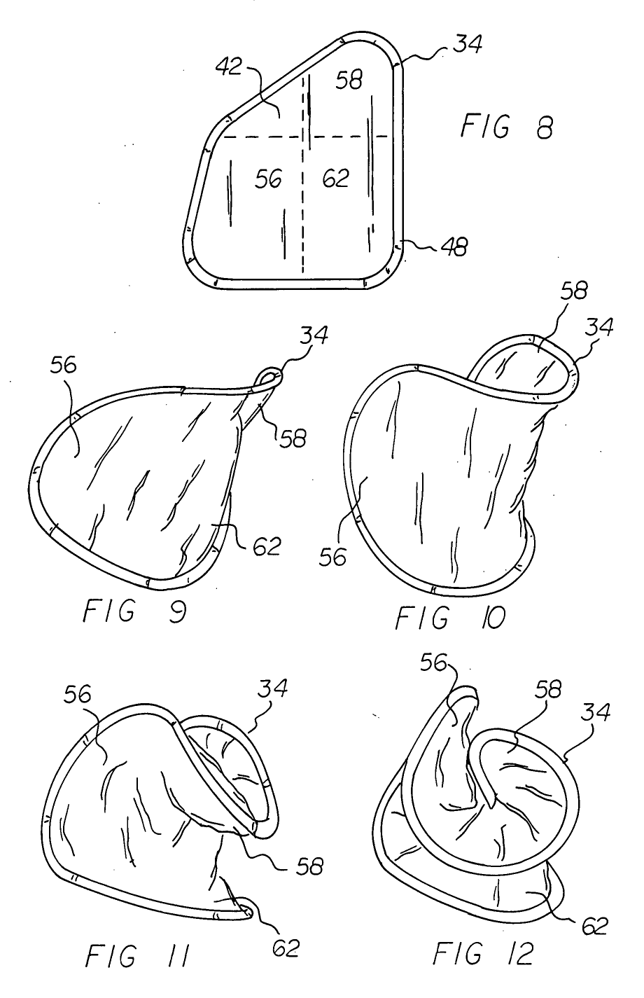

By securing wire loop 54 within peripheral sleeve 48, shade (34, 36 or 38) can be selectively oriented into either a deployed or stowed configuration. In describing these configurations, it is helpful to delineate three regions (56, 58 and 62) within interior area 42 of the shade (note FIGS. 4 and 8). In the deployed configuration, depicted in FIGS. 4 and 8, wire loop 54 is in an untension state and each of the three interior regions (56, 58 and 62) of the shade are co-planer to one another. Thus, the shade is substantially flat. In the stowed configuration wire loop 54 is twisted over onto itself to position the interior region 58 of the shade in-between the other two (56 and 62). As a consequence, the three interior areas (56, 58 and 62) are stacked one on top of another. This stowed configuration is illustrated in both FIGS. 7 and 14. Although wire loop 54 is in a tension state in the stowed configuration, loop 54 can nonetheless maintain this configuration due to the resilient nature of the spring steel alloy.

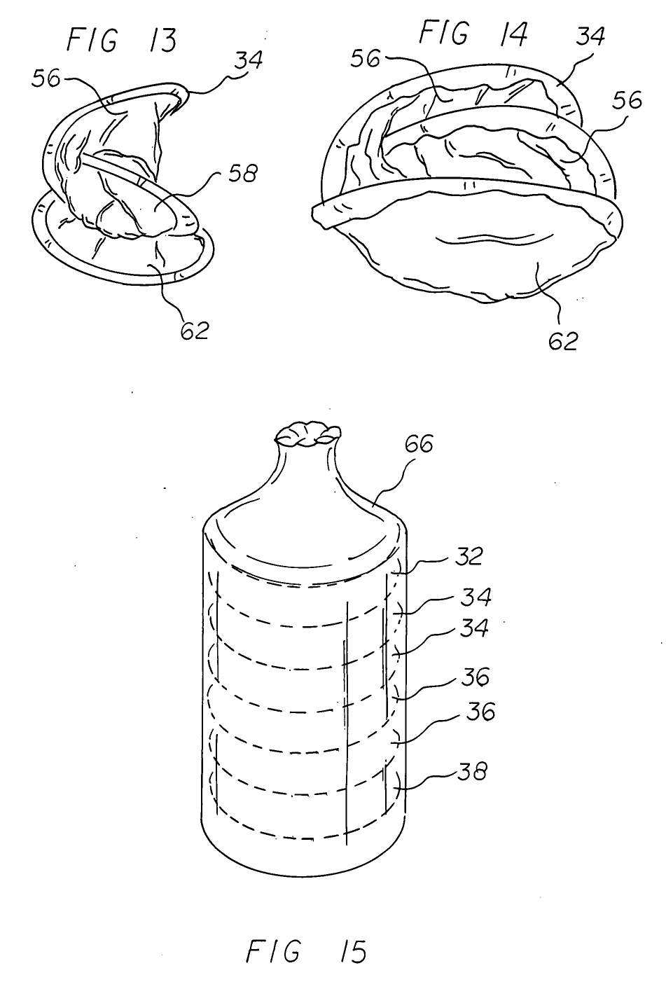

The transition from the deployed to the stowed configurations is illustrated in FIGS. 4 through FIG. 7. This series of Figures illustrates the folding of one of the rectangular overhead windshield shades 36 of the Longbow. As noted above, interior area 42 of this rectangular shade 36 is divided into three regions (56, 58 and 62). Folding is achieved by twisting the ends of the shade (56 and 62) such that the third region 58 is curled in-between the first and second regions (56 and 62) as noted in FIGS. 5 and 6. Again, the result is that the three regions (56, 58 and 62) overlie one another in a compact configuration (FIG. 7). FIGS. 8-14 illustrate the folding of a trapezoidal shaped side windshield 34 shade. Again, the shade is divided into three adjacent regions (56, 58 and 62). Folding is accomplished by bending the second region 58 downwardly as noted in FIGS. 9 through 11. Second region 58 is then tucked into the first region 56 as noted in FIGS. 12 and 13. Finally, the third region 62 is brought up underneath the second region 58, such that all three regions (56, 58 and 62) are overlying one another as noted in FIG. 14.

The manner in which a shade is installed while in its deployed configuration is illustrated in FIGS. 2-3. Namely, wire loop 54 of each shade can be inserted into the peripheral edges 64 surrounding the internal surface of an associated windshield. In this manner, interior area 42 of the shade 38 is positioned in facing relation to the internal surface of windshield 32. The remaining shades are similarly positioned upon the inside of the canopy. In order to sufficiently secure the shade in place, wire loop 54 is tensioned between opposing edges 64. This allows the shade to be maintained adjacent to the interior surface of the windshield without the need for any additional fasteners or securement. This is especially important when the shade is secured to an overhead windshield such as the overhead windshields 26 depicted in FIG. 1. Making sure the shade is firmly secured is also important for hinged windshields. Namely, prior to exiting the aircraft, the pilot or co-pilot will deploy the shades internally over the side windshields and then pivot the windshield upwardly to exit the aircraft. The process is reversed when a pilot or co-pilot enters the aircraft. In either case, it is important that the shade remain securely fastened while the windshield is being moved between opened and closed orientations.

Finally, all of the shades can be conveniently transported and/or stored while in their stowed configurations by way of the carrying case 66 depicted in FIG. 15. Carrying case 66 is preferably large enough to accommodate all of the shades that make up the system.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A system for selectively shielding the interior of an aircraft comprising:
an aircraft canopy including a number of windshields of differing shapes and sizes and that are positioned at a number of different orientations, with at least one of the windshields being positioned within an upper surface of the canopy and at least one of the windshields being hinged and selectively positionable between opened and closed positions, each of the windshields having an interior surface and an adjacent peripheral edge;
a number of shades, with the number of shades corresponding to the number of windshields within the aircraft canopy, each of the shades having a shape and size that corresponds to the shape and size of an associated windshield;
each of the shades being defined by three interior regions and a peripheral edge, each of the shades comprising a inner layer of a polyester fabric, an outer layer of a reflective vinyl laminate, a fabric sleeve secured about the peripheral edge, and a wire loop having a width of approximately ¼ inches positioned within the fabric sleeve, the wire loop being constructed from a spring steel alloy and having a tensioned and an un-tensioned state;
each of the shades having a deployed configuration wherein the shade is substantially flat and the wire loop is in the un-tensioned state, each of the shades also having a stowed configuration wherein the wire loop is twisted such that one of the interior regions is positioned in between the other two and the wire loop is in the tensioned state, each shade being selectively secured adjacent the interior surface of an associated windshield by positioning the wire loop into the adjacent peripheral edge of the associated windshield while the shade is in the deployed configuration, wherein the wire loop has a spring force sufficient to retain the loop adjacent an interior surface of the windshield regardless of the orientation of the windshield.
a carrying case for storing all of the shades in their stowed orientations.

2. An aircraft shielding system comprising:
an aircraft canopy including at least one windshield that is positioned or positionable in a substantially horizontal plane and which includes a peripheral edge;
a shade having a shape and size that corresponds to the windshield;
the shade having an interior area and a peripheral edge, a stiffener secured within the peripheral edge of the shade and having a spring force sufficient to retain the shade within the peripheral edge of the windshield while the windshield is in a substantially horizontal plane.

3. The aircraft shielding system as described in claim 2 wherein the interior area is comprised of a laminate with an outer surface of a reflective vinyl.

4. The aircraft shielding system as described in claim 2 wherein stiffener is a ¼ inch thick wire to loop.

5. The aircraft shielding system as described in claim 2 wherein the shade is divided into three interior areas and wherein the shade is foldable between a first orientation wherein the three areas are co-planar and a second orientation wherein the three areas over lie one another.

6. The aircraft shielding system as described in claim 2 wherein one of the windshields if hinged.

7. The aircraft shield system as described in claim 2 wherein a series of shades are included for a variety of windshields.

8. A system for shielding a windshield within an aircraft canopy, wherein the windshield is in a substantially horizontal orientation, the system comprising:
a shade having a shape and size that corresponds to the aircraft windshield;
the shade having an interior area and a peripheral edge, a spring secured within the peripheral edge of the shade, the spring having a spring force sufficient to retain the shade within the peripheral edge of the windshield.

9. The system as described in claim 8 wherein the shade is divided into three interior areas and wherein the shade is foldable between a first orientation wherein the three areas are co-planar and a second orientation wherein the three areas over lie one another.
